(19) United States
(12) Patent Application Publication
(10) Pub. No.: US 2026/0219489 A1
(43) Pub. Date: Jul. 30, 2026

(54) METHODS AND APPARATUS FOR FOURIER PTYCHOGRAPHY RECONSTRUCTION PROCESSING

(71) Applicant: SIEMENS HEALTHCARE DIAGNOSTICS INC., Tarrytown, NY (US)

(72) Inventors: Abhijeet A. JOSHI, Bangalore, Karnataka (IN); Mohiudeen AZHAR, Bangalore, Karnataka (IN)

(21) Appl. No.: 19/141,467

(22) PCT Filed: Dec. 22, 2023
(86) PCT No.: PCT/US2023/085779

§ 371 Date: Jun. 20, 2025

(30) Foreign Application Priority Data
Dec. 23, 2022 (IN) 202211075050

(51) Int. Cl. G02B 21/36; G02B 21/06

(52) U.S. Cl. CPC G02B 21/367; G02B 21/06; G02B 21/361

(57) ABSTRACT

A method of Fourier ptychography microscopy (FPM) that includes obtaining images of a sample using an FPM system is provided. The method includes storing the images in a memory, uploading the images to a graphics processing unit (GPU), and performing FPM reconstruction using the GPU to generate a reconstructed image. The FPM reconstruction includes performing portions of the FPM reconstruction in parallel on the GPU to reduce FPM reconstruction time.

The present patent document claims the benefit of Indian Patent Application No. 202211075050, filed Dec. 23, 2022, which is hereby incorporated by reference in its entirety.

### FIELD

The present application relates to diagnostic imaging, and more particularly to methods and apparatus for Fourier ptychography reconstruction processing.

### BACKGROUND

Fourier ptychography microscopy (FPM) is a microscopy technique that allows high-resolution imaging over a wide field of view. FPM employs an array of light sources to illuminate a sample during capture of a set of low-resolution images. Each low-resolution image is illuminated by a different light source or set of light sources from the array. The captured low-resolution images are then stitched together in the Fourier domain to generate a high-resolution image.

FPM provides a number of advantages over conventional microscopy such as a significantly higher space-bandwidth product, a simple, low-cost setup with few mechanical actuations, and a small footprint. However, due to the number of images that are to be captured, FPM suffers from long image acquisition times, which limits its applicability to imaging moving samples. Reconstructing a high-resolution image from the captured low-resolution images may also be prohibitively time consuming in some applications.

Accordingly, a need exists for improved methods and apparatus for FPM.

### SUMMARY

In some embodiments, a method of Fourier ptychography microscopy (FPM) is provided that includes obtaining images of a sample using an FPM system; storing the images in a memory; uploading the images to a graphics processing unit (GPU); and performing FPM reconstruction using the GPU to generate a reconstructed image, where the FPM reconstruction includes performing portions of the FPM reconstruction in parallel on the GPU to reduce FPM reconstruction time.

In some embodiments, a Fourier ptychographic imaging system includes: a plurality of light sources configured to emit light onto a sample location; an optical system configured to image at least a portion of a sample positioned at the sample location; an image capture device configured to capture images of the sample through the optical system under different light conditions provided by the plurality of light sources; a processor; a GPU in communication with the processor; and a memory coupled to the processor. The memory includes computer executable instructions stored therein that, when executed by the processor, cause the processor to: (a) obtain images of a sample positioned at the sample location; (b) store the images in the memory; (c) upload the images to the GPU; and (d) initiate FPM reconstruction using the GPU to generate a reconstructed image, where the FPM reconstruction includes performing portions of the FPM reconstruction in parallel on the GPU to reduce FPM reconstruction time.

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

Other features and aspects of the present invention will become more fully apparent from the following detailed description, the appended claims, and the accompanying drawings.

### BRIEF DESCRIPTION OF THE DRAWINGS

FIG. 1A illustrates an example Fourier ptychography microscopy (FPM) system provided in accordance with embodiments of the disclosure.

FIG. 1B illustrates an example light source array for use with the FPM system of FIG. 1A in accordance with embodiments provided herein.

FIG. 2 illustrates an example method of Fourier ptychography microscopy in accordance with embodiments provided herein.

FIGS. 3A-3B illustrate example low-resolution images and linear arrays used to store image data from the low-resolution images in accordance with embodiments provided herein.

FIG. 4 illustrates an example low-resolution image compared to an FPM reconstructed high-resolution image in accordance with embodiments provided herein.

FIG. 5A illustrates an example method of employing a GPU for FPM reconstruction in which a sequence of kernel calls and fast Fourier transform (FFT) calls are employed in accordance with embodiments provided herein.

FIG. 5B illustrates an example method of employing a GPU for FPM reconstruction in which a single kernel call is employed in accordance with embodiments provided herein.

FIG. 6 illustrates another example method of employing a GPU for FPM reconstruction in which a sequence of kernel calls and FFT calls are employed in accordance with embodiments provided herein.

FIG. 7 illustrates another example method of employing a GPU for FPM reconstruction in which a single kernel call is employed in accordance with embodiments provided herein.

### DETAILED DESCRIPTION

Independent of the grammatical term usage, individuals with male, female or other gender identities are included within the term.

As stated previously, while FPM provides a number of advantages, use of FPM may be limited in some applications due to the substantial length of time required to obtain results with this technique. The main delays associated with FPM include the time required to capture numerous low-resolution images and the time required to reconstruct a high-resolution image from captured low-resolution images (e.g., which may be orders of magnitude longer than then image capture time). Embodiments provided herein may significantly reduce FPM image processing time, allowing FPM to be employed in a wider range of applications (e.g., any application that benefits from faster results, such as clinic testing for medical diagnoses/treatment or the like).

In accordance with some embodiments, processing of low-resolution images to reconstruct a high-resolution image using FPM is performed with the use of one or more graphics processing units (GPUs). The use of one or more GPUs may greatly reduce the time bottleneck associated with image reconstruction during FPM without compromising image quality, generalizability, or portability of the FPM system. Such an approach is scalable and portable and may offer up to a 500 to 10,000 times performance improvement compared to a serial, central processing unit (CPU) FPM implementation.

In an example embodiment, images of a sample are obtained using a Fourier ptychography microscopy (FPM) system. For example, an array of light sources (e.g., an array of light emitting diodes (LEDs)) may be used to illuminate a sample while the sample is imaged with a low-resolution optical element and an image capture device such as a camera. Each captured image may be stored in a memory (e.g., a memory associated with a central processing unit (CPU) in communication with the image capture device), such as by storing image data for each captured image in the memory. Thereafter, the images (e.g., as image data) are uploaded to a graphics processing unit (GPU). FPM reconstruction may then be performed using the GPU to generate a reconstructed image. For example, portions of the FPM reconstruction may be performed in parallel on the GPU to reduce FPM reconstruction time.

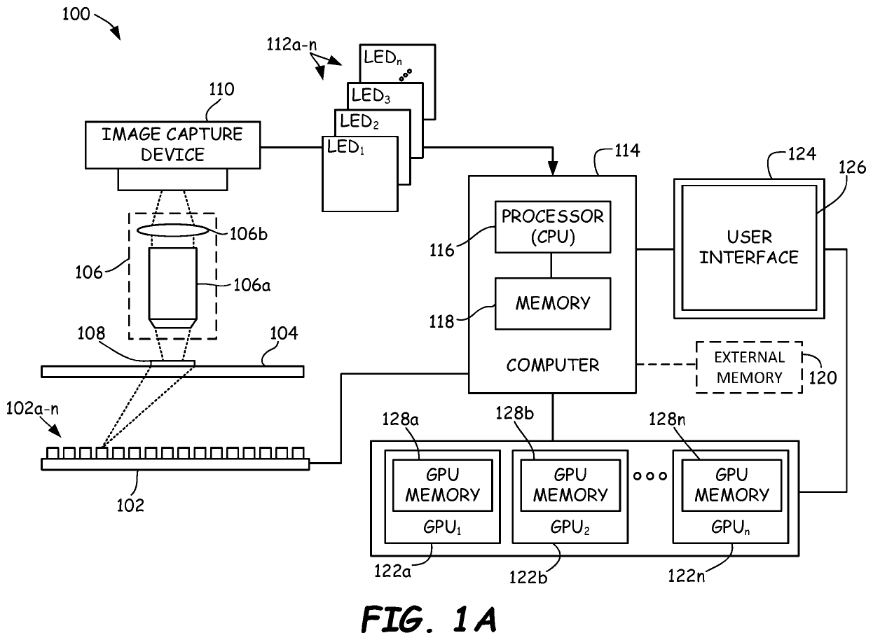

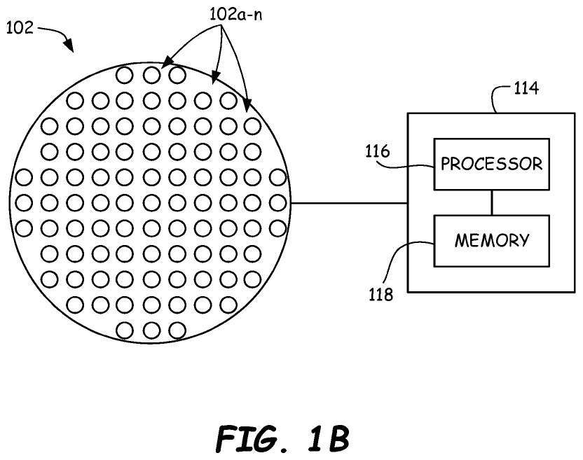

These and other embodiments provided herein are described below with reference to FIG. 1A-7.

FIG. 1A illustrates an example Fourier ptychography microscopy (FPM) system 100 provided in accordance with embodiments of the disclosure. With reference to FIG. 1A, FPM system 100 includes a light source array 102 having a plurality of light sources 102a-n configured to emit light onto a sample location 104.

An optical system 106 is configured to image at least a portion of a sample 108 positioned at the sample location 104. As shown in FIG. 1A, an image capture device 110 is configured to capture images (e.g., low-resolution images 112a-n) of sample 108 through optical system 106 under different light conditions provided by the plurality of light sources 102a-n of light source array 102.

A computer 114 having a processor 116 may be coupled to image capture device 110 and receive images (e.g., low-resolution images) captured by image capture device 110 for storage in memory. In some embodiments, the images may be stored in a memory 118 associated with processor 116 (e.g., RAM, a hard drive, and/or another memory type).

Alternatively or additionally, image data may be stored in an external memory 120 (e.g., local external memory, remote storage, cloud storage, or a combination thereof).

One or more graphics processing units (GPUs) 122a-n may be coupled to processor 116 as described further below. Any suitable number of GPUs may be used (e.g., 1, 2, 5, 10, etc.). A display 124 having a user interface 126 may be coupled to the processor 116 and/or one or more GPUs 122a-n, such as for displaying low-resolution images, reconstructed, high-resolution images, and/or the like.

Light source array 102 may include a uniform or non-uniform array of light sources 102a-n that may be controlled by processor 116 or another suitable processor, microprocessor, controller, microcontroller, digital signal processor (DSP), field programmable gate array (FPGA) configured to perform as a microcontroller, or the like. In some embodiments, light sources 102a-n of light source array 102 may be individually controlled and operated alone or in combination with one or more light sources 102a-n. Example light sources 102a-n may include light emitting diodes (LEDs), monochrome or single-bandwidth emission light sources, multiple bandwidth light sources (e.g., RGB LEDs), super-luminescent LEDs, laser diodes, especially semiconductor laser diodes, thermal emitters, fiber-based light sources, etc. All light sources 102a-n may be identical, or one or more light sources 102a-n may differ in at least one of the following characteristics: wavelength, spectral bandwidth, spatial emission characteristics, temporal emission characteristics such as continuous or pulsed operation, coherence parameters such as degree of temporal and/or spatial coherence, brightness or extent, and/or the like.

In some embodiments, a light source array 102 with 256 individually-controllable LEDs may be employed in an x-y grid (e.g., 16×16 LEDs), with each LED separated by approximately 1 to 10 mm and emitting at approximately 0.4 to 0.7 micrometers, as shown in FIG. 1B. In one particular embodiment, the LEDs may be spaced by approximately 2.5-3.5 mm and employ wavelengths of 0.45, 0.51, and/or 0.62 micrometers. Other light source array arrangements, numbers of light sources, types of light sources, and/or emitting wavelengths may be employed. As mentioned, while processor 116 is shown controlling light source array 102 in FIG. 1B, in other embodiments, a different processor or other control mechanism may be employed to control operation of light source array 102.

Optical system 106 (FIG. 1A) may include an optical objective 106a and a focusing lens 106b, for example. Other optical components may be used. As stated, one of the benefits of FPM is that FPM allows use of low-cost, low-resolution optical components. In some embodiments, optical objective 106a may have a numerical aperture (NA) of approximately 0.05-0.9. Other NA optical objectives may be employed. In one or more embodiments, focusing lens 106b may be a tube lens, such as an achromatic tube lens, or another suitable lens. Image capture device 110 may include any suitable imaging device capable of imaging a sample through optical system 106 such as a CMOS sensor or the like. Example pixel sizes may range from about 1 micrometer to about 10 micrometers, although other pixel sizes may be used.

In some embodiments, processor 116 may be a central processing unit (CPU). In other embodiments, processor 116 may include and/or be implemented as one or more other computational resources such as, but not limited to, a microprocessor, a microcontroller, an embedded microcontroller, a digital signal processor (DSP), a field programmable gate array (FPGA) configured to perform as a microcontroller, or the like. Computer 114 may include any suitable computing device such as a tablet computer, laptop computer, desktop computer, a server, or the like.

Memory 118 and/or 120 may be any suitable type of memory, such as, but not limited to, one or more of a volatile memory and/or a non-volatile memory (e.g., RAM, DRAM, SRAM, cache, a hard drive, a combination of the same, etc.). In other words, memory 118 and/or 120 may include more than one type of memory. Memory 118 and/or 120 may have a plurality of instructions stored therein that, when executed by processor 116, cause processor 116 to perform various actions specified by one or more of the stored instructions. Code and data may be stored in a first type of memory (e.g., a hard drive) and transferred to a second type of memory for execution (e.g., RAM). In some embodiments, memory 118 and/or 120 may include either or both.

GPUs 122a-n may include any suitable graphics processing units. In some embodiments, one or more of GPUs 122a-n may include an RTX 30 Series GPU, such as an RTX 3080 or 3090 available from Nvidia Corporation of Santa Clara, CA. Other GPUs may be employed. Each GPU 122a-n may include a memory 128a-n, respectively, such as SRAM, DRAM, or the like, for example.

Display 124 may include any suitable display such as a light-emitting diode (LED) display, liquid-crystal display (LCD), organic light-emitting-diode (OLED) display, or the like. User interface 126 may include a display screen or a touch panel and/or screen, an audio speaker, a microphone, or any combination thereof, for example. In some embodiments, user interface 126 may be controlled by the processor 116, and functionality of user interface 126 may be implemented, at least in part, by computer-executable instructions (e.g., program code or software) stored in memory 118 and/or executed by processor 116.

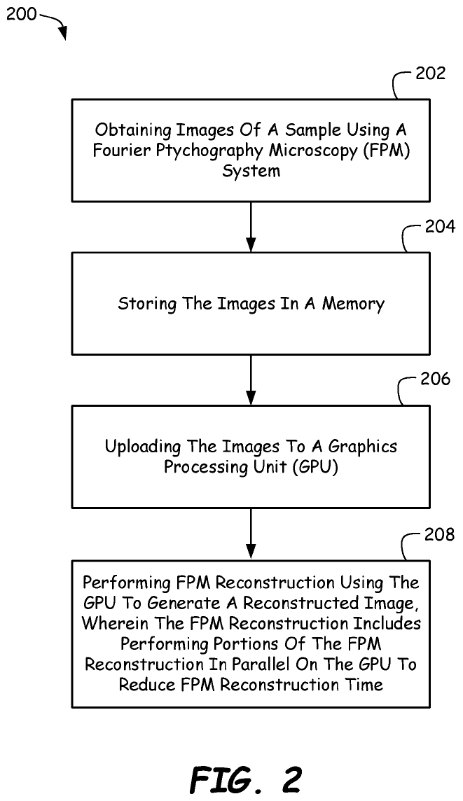

FIG. 2 illustrates an example method 200 of Fourier ptychography microscopy in accordance with embodiments provided herein. With reference to FIG. 2, in block 202, images of a sample are obtained using an FPM system. For example, sample 108 may be placed at sample location 104 and illuminated using one or more light sources from light source array 102. Image capture device 110 may then be employed to image sample 108 through optical system 106. Specifically, image capture device 110 may capture a low-resolution image 112a of sample 108. For each subsequent image 112b-n, light source array 102 may be adjusted so that different light sources 102a-n or different arrangements of light sources 102a-n are employed to illuminate the sample 108. In one or more embodiments, the intensities of one or more light sources may be varied.

In some embodiments, approximately 40-400 low-resolution images may be obtained and processed for each high-resolution image generated by FPM system 100. Fewer or more low-resolution images may be used. The pixel count of each low-resolution image may range widely. In some embodiments, pixel count may be about 3000×4000 pixels per image (e.g., depending on the sensor size employed within image capture device 110), for example. Larger or smaller image pixel counts may be employed.

After images of the sample are obtained, in block 204, the images are stored in a memory. In some embodiments, each low-resolution image 112a-n is stored in memory 118 (e.g., associated with the processor 116). Alternatively, low-resolution images 112a-n may be stored in external memory 120.

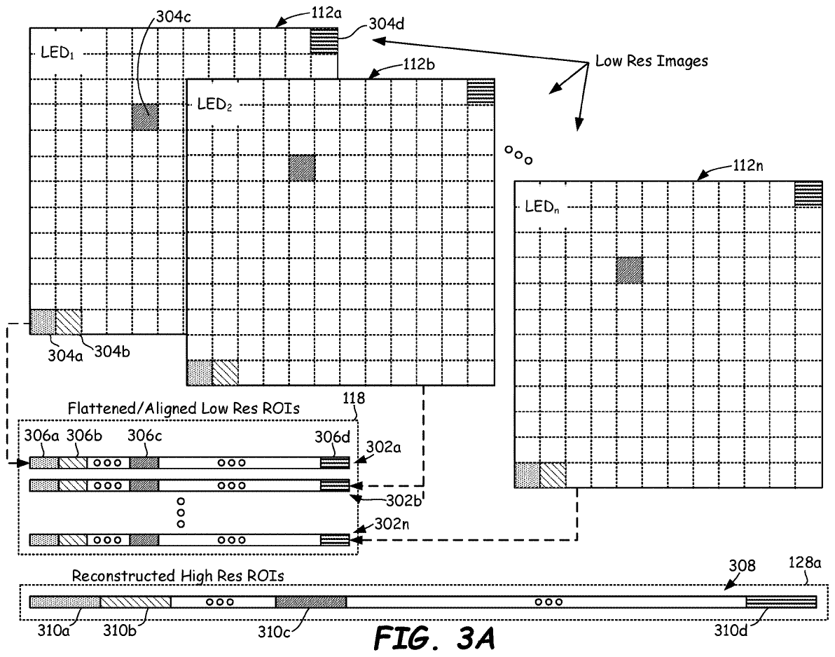

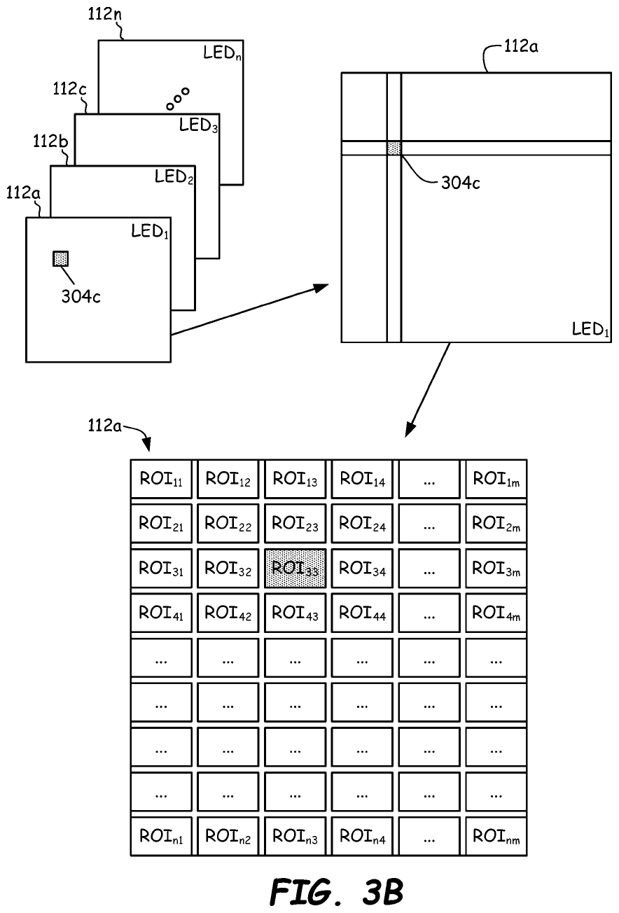

To simplify the FPM reconstruction of a high-resolution image from a set of low-resolution images using a GPU of the FPM system 100, image data for the low-resolution images 112a-n may be flattened and aligned while being stored in memory as described below with reference to FIGS. 3A-3B.

FIGS. 3A-3B illustrate example low-resolution images 112a-n and linear arrays (e.g., linear arrays 302a-n within memory 118) used to store the image data from low-resolution images 112a-n in accordance with embodiments provided herein. As shown in FIG. 3A, each low-resolution image 112a-n may be divided into a plurality of tiles or regions of interest (ROIs) (ROI₁₁-ROIₙₘ in the example embodiment of FIG. 3B). For example, in some embodiments, each low-resolution image may be divided into approximately 200-400 ROIs per image. Other numbers of ROIs may be employed.

Similarly, in some embodiments, each region of interest within an image may include a predefined number of pixels, such as 192×192 pixels or another number of pixels per ROI. Further, in some embodiments, at least some adjacent regions of interest may share one or more image pixels. As will be described further below, in accordance with embodiments provided herein, each ROI may be processed separately and in parallel using one or more of GPUs 122a-n to significantly reduce the reconstruction time of high-resolution images from low-resolution images. For example, each pixel of each ROI may be processed in parallel using one or more GPUs.

Returning to FIG. 3A, four ROIs 304a, 304b, 304c, and 304d are shown with shading in low-resolution images 112a, 112b, and 112n. These ROIs represent two-dimensional data that is to be stored in one-dimensional arrays 302a-n (e.g., within memory 118, although other memory locations such as external memory 120 may be employed). To accomplish this, each ROI is flattened when stored in memory. For example, image data for ROI 304a of image 112a is shown flattened when stored in linear array 302a of memory 118 (e.g., as depicted by ROI 304a being represented as a square in low-resolution images 112a and corresponding image data 306a being represented as a rectangle in linear array 302a).

Additionally, ROI image data is aligned within linear arrays 302a-n. For example, image data for each ROI is arranged contiguously within each linear array. As shown in FIG. 3A, within memory 118, image data for ROI 304a is next to image data for ROI 304b within linear array 302a. In other words, within each linear array, image data is stored together without intervening data being stored between ROI image data. Therefore, in some embodiments, storing images in memory may include defining a plurality of ROIs within each image and flattening and aligning image data ROI by ROI in the memory. Other methods for arranging image data within a memory may be employed. In some embodiments, additional processing or pre-processing of data may be implemented, such as to reduce noise in the image data, remove artifacts from the image data, and/or remove stray light intensities from the image data.

Returning to FIG. 2 and method 200, after storing the low-resolution images in memory, in block 206, the captured images are uploaded to a GPU. This may include transferring image data from CPU memory to GPU memory. For example, image data stored in linear arrays 302a-n (FIG. 3A) of memory 118 may be transferred to GPU memory 128a (FIG. 1A) of GPU 122a (e.g., for storage in one or linear arrays not shown) or to one or more other GPU memories if additional GPUs are employed. In some embodiments, additional pre-processing of data may be implemented within GPU 122a (e.g., and/or another GPU if employed), such as to reduce noise in the image data, remove artifacts from the image data, and/or remove stray light intensities from the image data.

After the images are uploaded to a GPU, in block 208, FPM reconstruction is performed using the GPU to generate a reconstructed image, where portions of the FPM reconstruction are performed in parallel on the GPU to reduce FPM reconstruction time (e.g., rather than performing FPM reconstruction serially using one or more CPUs). For example, in accordance with embodiments provided herein, FPM reconstruction on each region of interest of a low-resolution image is performed independently of other regions of interest within the image, and the reconstructed image is generated from the FPM reconstruction of each region of interest within each image. For example, FPM reconstruction may be performed on each region of interest of each image in parallel using one or more GPUs. For example, FPM reconstruction may be performed on each region of interest of each image in parallel using GPU 122a (and/or one or more other GPUs 122b-n if desired) by performing pixel-level parallelization (as described further below).

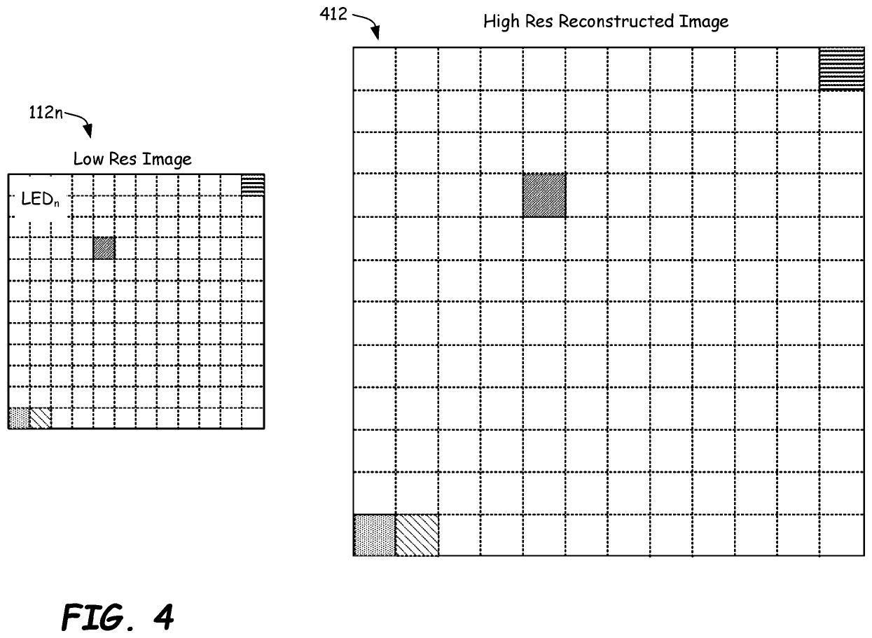

In many instances, the FPM reconstruction performed on one or more low-resolution ROIs generates one or more FPM reconstructed ROIs having a larger number of pixels than the low-resolution ROIs employed during reconstruction. FIG. 3A illustrates an example linear array 308 (e.g., of memory 128a of GPU 122a) containing reconstructed, high-resolution ROI image data 310a, 310b, 310c, and 310d generated by the FPM reconstruction of low-resolution ROIs of low-resolution images 112a-n (e.g., including low-resolution ROI image data 306a, 306b, 306c, and 306d, respectively, of linear array 302a). As seen in linear array 308, high-resolution ROI image data 310a, 310b, 310c, and 310b contain more data (e.g., more pixels) than low-resolution ROI image data 306a, 306b, 306c, and 306d. This is also shown in FIG. 4, which illustrates an example low-resolution image 112n compared to an FPM reconstructed high-resolution image 412 in which individual ROIs may be larger than corresponding ROIs in the low-resolution image 112n. Likewise, the overall length and width of the high-resolution image 412 may be increased compared to the length and width of the low-resolution images used to generate the high-resolution image 412 by FPM reconstruction.

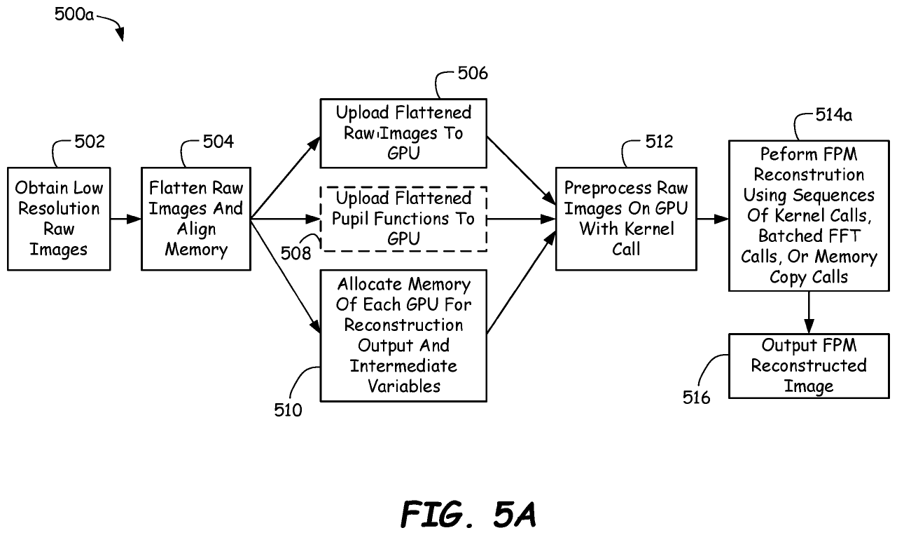

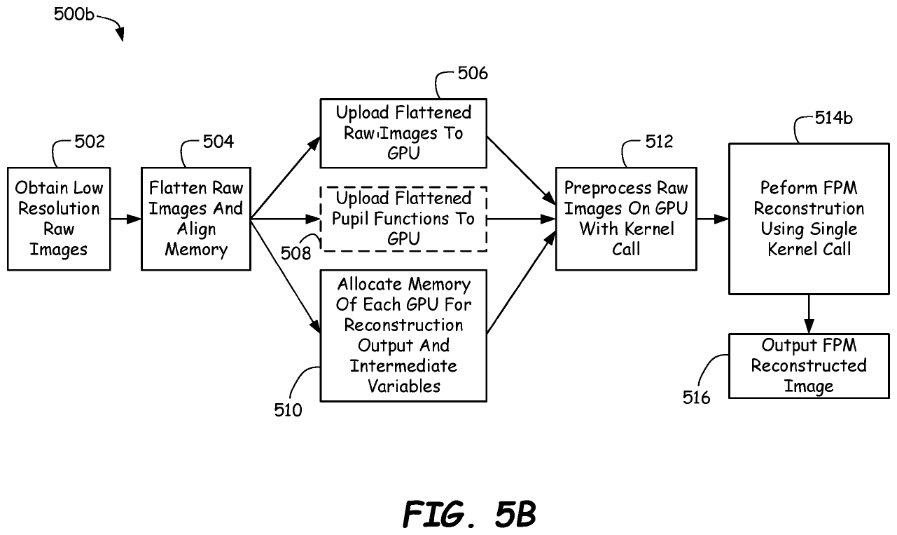

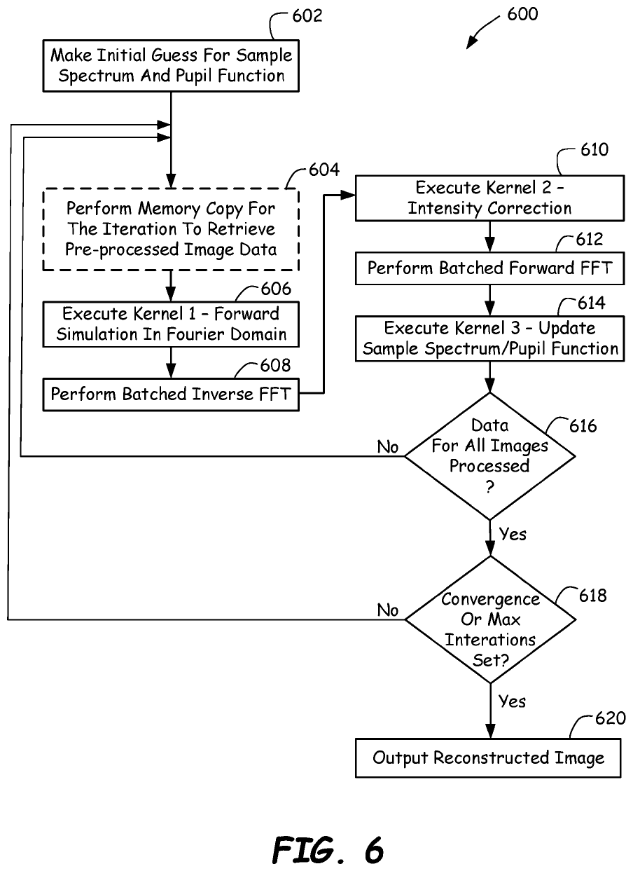

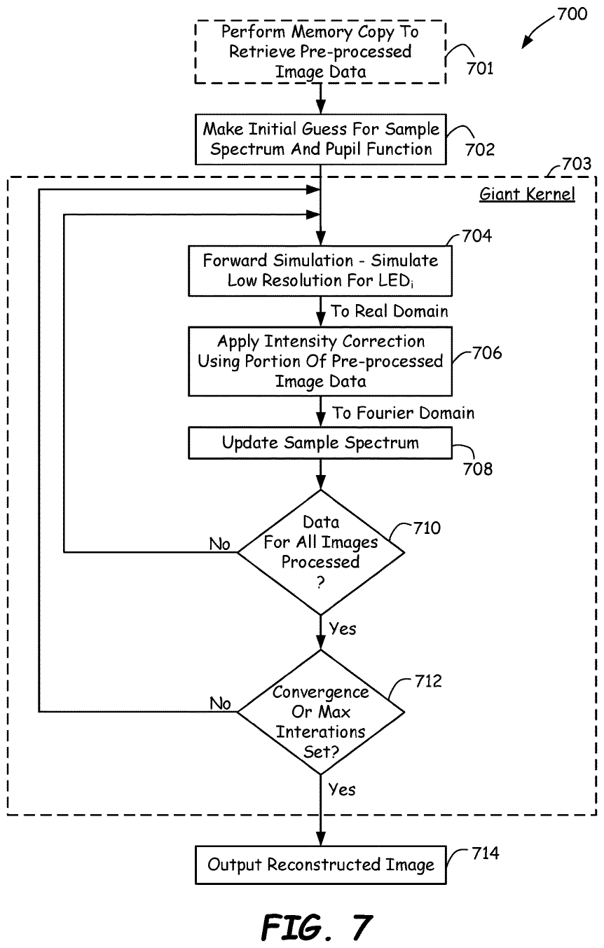

Example embodiments for carrying out FPM reconstruction are described below with reference to FIGS. 5A-7. For example, FIGS. 5A and 6 illustrate example methods 500a and 600, respectively, of employing a GPU for FPM reconstruction in which a sequence of kernel calls and fast Fourier transform (FFT) calls (e.g., forward FFT and/or inverse FFT calls) are employed, while FIGS. 5B and 7 illustrate example methods 500b and 700, respectively, of employing a GPU for FPM reconstruction in which a single kernel call is employed. As used herein, in some embodiments, a sequence of FFT calls may include both forward and inverse FFT calls.

Numerous algorithms have been proposed for implementing Fourier ptychography microscopy such the alternating projection methods described in R. W. Gerchberg and W. O. Saxton, “A practical algorithm for the determination of phase from image and diffraction plane pictures,” Optik, Bd. 35, pp. 227-246, (1972) and X. Ou, G. Zheng, and C. Yang, “Embedded pupil function recovery for Fourier ptychographic microscopy,” Optics Express, Bd. 22, Nr. 5, pp. 4960-4972, 3(2014 ) (hereinafter “Ou et al.”) and the maximum-likelihood estimation formulations of L. Bian, J. Suo, G. Zheng, K. Guo, F. Chen, and Q. Dai, “Fourier ptychographic reconstruction using Wirtinger flow optimization,” Optics Express, Bd. 23, Nr. 4, pp. 4856-4866, 2 (2015) and L. Bian, J. Suo, J. Chung, X. Ou, C. Yang, F. Chen, and Q. Dai, “Fourier ptychographic reconstruction using Poisson maximum likelihood and truncated Wirtinger gradient,” Scientific Reports, Bd. 6, Nr. 1, p. 27384, 7 (2016). Other example FPM algorithms include AI-based approaches as described in T. Nguyen, Y. Xue, Y. Li, L. Tian, and G. Nehmetallah, “Deep learning approach for Fourier ptychography microscopy,” Optics Express, Bd. 26, Nr. 20, pp. 26470-26484, 10(2018 ) and Y. Rivenson, Y. Zhang, H. Günaydin, D. Teng and A. Ozcan, “Phase recovery and holographic image reconstruction using deep learning in neural networks,” Light: Science and Applications, Bd. 7, Nr. 2, p. 17141, 2 (2018). While some embodiments described herein relate to pupil function recovery algorithms, such as those described in Ou et al., it will be understood that other algorithms may be employed.

With reference to FIG. 5A, in block 502, low-resolution “raw” images of a sample are obtained. For example, sample 108 may be placed at sample location 104 and illuminated using one or more light sources from light source array 102. Image capture device 110 then may be employed to image sample 108 through optical system 106. Specifically, image capture device 110 may capture a low-resolution image 112a of sample 108. For each subsequent image, light source array 102 may be adjusted so that different light sources 102a-n or different arrangements of light sources 102a-n are employed to illuminate the sample 108. In some embodiments, approximately 40-400 low-resolution images may be obtained and processed for each high-resolution image generated by FPM system 100. Fewer or more low-resolution images may be used.

Once the low-resolution images are obtained, in block 504, the images are flattened and aligned in memory (e.g., image data for the images is flattened and aligned in memory). As described previously with reference to FIGS. 3A-3B, in some embodiments, each low-resolution image (e.g., low-resolution images 112a-n) may be divided into a plurality of regions of interest (ROIs). For example, in some embodiments, each low-resolution image may be divided into approximately 200-400 ROIs per image. Other numbers of ROIs may be employed. In general, the size of the ROIs employed may be limited by the physical constraint associated with spatio-temporal coherence of the illumination as well as by the applicability of the spatially calibrated or geometrically derived parameters. Additionally, spatially dependent aberrations associated with the optical apparatus (e.g., optical system 106) may also pose a constraint on the region-of-interest size that may be used to obtain high quality reconstruction.

In accordance with embodiments provided herein, Fourier ptychographic reconstruction may be performed independently on each ROI. This feature makes the FPM reconstruction method highly suitable for parallelization. However, choice of parallelization strategy and memory management is important to optimizing resource usage and performance.

ROIs represent two-dimensional data that is to be stored in one-dimensional arrays within memory 118 (or other memory locations such as external memory 120). To accomplish this, each ROI is flattened when stored in memory. For example, as shown in FIG. 3A, image data for ROI 304a of low-resolution image 112a is shown flattened (e.g., reduced from 2D data to 1D data) when stored in linear array 302a of memory 118 (e.g., as depicted by ROI 304a being represented as a square in low-resolution images 112a and corresponding image data 306a being represented as a rectangle in linear array 302a). Additionally, ROI image data is aligned when stored in memory (e.g., within linear arrays 302a-n). For example, image data for each ROI is arranged contiguously within each linear array. As shown in FIG. 3A, within memory 118, image data for ROI 304a is next to image data for ROI 304b within linear array 302a without intervening data being stored between ROI image data. Other methods for arranging ROI image data within a memory may be employed. As describe previously, in one or more embodiments, additional pre-processing of data may be implemented using processor 116, such as to reduce noise in the image data, remove artifacts from the image data, and/or remove stray light intensities from the image data.

In some embodiments, following image flattening and alignment, in block 506, the flattened and/or aligned low-resolution images are uploaded to a GPU (e.g., to be employed during FPM reconstruction of a high-resolution image based on the captured low-resolution images). For example, image data from the memory of a CPU (e.g., memory 118 of processor 116) may be transferred to a memory of the GPU (e.g., memory 128a of GPU 122a). As a specific example, image data stored in linear arrays 302a-n of memory 118 of processor 116 may be transferred to GPU memory 128a of GPU 122a (e.g., for storage in one or more linear arrays not shown) or to one or more other GPUs if additional GPUs are employed.

In block 508, in some embodiments, a pupil function characterizing the optical system (e.g., optical system 106) may be uploaded to the GPU (or GPUs) to be employed for FPM reconstruction. Alternatively, a pupil function may be reconstructed from the low-resolution images 112a-n. For example, the pupil function may be recovered employing a pupil function recovery algorithm such as that described in Ou et al. As a specific example, the embedded pupil function recovery (EPRY) algorithm of Ou et al. may be employed during FPM reconstruction to recover the pupil function of the optical system used to image a sample (e.g., optical system 106 used to image sample 108 in FIG. 1A).

Referring again to FIG. 5A, in block 510, memory within the GPU (or GPUs) is allocated for FPM reconstruction output and intermediate variables (e.g., variables that may be used during FPM reconstruction but that are not output with the reconstructed image). As an example, one or more linear arrays in GPU 122a (or another GPU) may be allocated for FPM reconstruction and/or intermediate variables.

In block 512, the image data for the low-resolution images may be pre-processed within the GPU (or GPUs). For example, pre-processing of data may be implemented within GPU 122a (and/or another GPU if employed), to reduce noise in the image data, remove artifacts from the image data, and/or remove stray light intensities from the image data (e.g., assuming pre-processing of the image data was not already performed by processor 116).

In block 514a, FPM reconstruction is performed by the GPU (or GPUs) using a sequence of kernel calls, batched fast Fourier transform (FFT) calls (e.g., forward and/or inverse FFT calls), and/or memory copy calls. In some embodiments, memory 118 (FIG. 1A) may include computer executable instructions that, when executed by processor 116, cause processor 116 to perform a sequence of kernel calls and FFT calls, and in some embodiments, one or more memory copy calls to GPU 122a (and/or any other GPU employed). An example sequence of kernel calls, batched FFT calls, and memory copy calls is described below with reference to FIG. 6. The sequence of kernel calls, batched FFT calls, and/or memory copy calls cause GPU 122a to perform FPM reconstruction on ROIs within each low-resolution image 112a-n. For example, FPM reconstruction on each ROI may be performed independently of other ROIs within the image and in parallel using at least one GPU (e.g., one or more of GPUs 122a-n). A high-resolution reconstructed image may then be generated from the FPM reconstruction of each ROI within each image. This parallel processing of ROIs within a GPU significantly reduces FPM reconstruction time when compared to serial processing with one or more CPUs and allows pixel-level parallelization to be employed during ROI reconstruction. Example FPM reconstruction algorithms and processes are described further below.

Reconstructed ROIs for the reconstructed high-resolution image may be stored within GPU memory (e.g., memory 128a of GPU 122a) prior to output, such as is shown by linear array 308 of FIG. 3A.

In block 516, following FPM reconstruction, the FPM reconstructed image is output. For example, the image data generated by GPU 122a (and/or any other GPU employed) during FPM reconstruction for each ROI may be assembled into a high-resolution reconstructed image (e.g., such as high-resolution image 412 of FIG. 4) and output via display 124 and/or user interface 126 (FIG. 1A). In some embodiments, GPU 122a may output the high-resolution image directly to display 124, while in other embodiments, GPU 122a may transfer the high-resolution image data to memory 118 of processor 116, and processor 116 may output the high-resolution image using display 124 and/or user interface 126.

With reference to FIG. 5B, blocks 502-512 and block 516 of example method 500b (e.g., for employing a GPU during FPM reconstruction) may be similar to or the same as blocks 502-512 and 516 of method 500a. However, block 514a of method 500a is replaced with block 514b in method 500b. Specifically, in block 514b of method 500b, FPM reconstruction is performed using a single kernel call. In other words, FPM reconstruction on each ROI of the low-resolution images 112a-n may be performed in parallel (e.g., using one or more GPUs 122a-n) through use of a single kernel call. In some embodiments, memory 118 (FIG. 1A) may include computer executable instructions that, when executed by processor 116, cause processor 116 to perform a single kernel call to perform FPM reconstruction of a high-resolution image from low-resolution images 112a-n, as described further below with reference to FIG. 7. Following blocks 502-512 and the single kernel call of block 514b, the FPM reconstructed, high-resolution image may be output in block 516.

With reference to FIG. 6 and method 600, FPM reconstruction may be started in block 602 by making an initial guess for the sample spectrum and the pupil function. The initial guess for the sample spectrum is a frequency domain estimate of the high-resolution image that will be produced by FPM reconstruction using the low-resolution images (e.g., low-resolution images 112a-n). Any suitable initial guess may be employed, and such an initial guess may be dependent upon the particular FPM algorithm(s) employed during FPM reconstruction. In some embodiments, the initial guess for the sample spectrum may be based on one or more of the low-resolution images (e.g., one or a combination of low-resolution images, a heuristically defined initial guess based on one or more low-resolution images, etc.). In other embodiments, the initial guess for the sample spectrum may be based on randomized data.

In embodiments in which the pupil function of the optical system (e.g., optical system 106) is measured, estimated, or otherwise determined prior to FPM reconstruction, no initial guess for the pupil function is required, and the pupil function may be uploaded for use during FPM reconstruction (e.g., to GPU 122a and/or any other GPU employed). There may be instances in which different pupil functions may be employed for different low-resolution images and/or for different ROIs within low-resolution images. In such cases, FPM reconstruction may include uploading one or more pupil functions to a GPU (e.g., and employing the one or more pupil functions during FPM reconstruction).

If a pupil function is to be recovered (e.g., determined) during the FPM reconstruction process, the initial guess for the pupil function may depend on the particular pupil function recovery algorithm(s) being employed, pupil function pre-characterization information available, known aberrations of the optical system being employed, etc. For example, for the embedded pupil function recovery (EPRY)-FPM algorithm of Ou et al., the initial pupil function may be a low pass filter having an applicable shape (e.g., circular). In general, any suitable binary mask or computed initial pupil function may be employed.

Returning to FIG. 6, following an initial guess for the sample spectrum and/or pupil function, in block 604, a memory copy is performed to retrieve pre-processed low-resolution image data for transfer to one or more GPUs and use during FPM reconstruction. For example, processor 116 may initiate a memory copy operation to transfer low-resolution image data from memory 118 of processor 116 to memory 128a of GPU 122a. The amount of pre-processed image data retrieved may depend, for example, on the size of the memory available within the GPU employed (e.g., the size of memory 128a in GPU 122a). In some embodiments, the memory copy operation may retrieve all ROI data associated with a particular low-resolution image (e.g., low-resolution image 112a, for example). In other embodiments, GPU hardware with sufficient compute capability may allow for optimized paging functionality to retrieve data on an as-needed basis. As stated, pre-processed image data may include low-resolution image data that is flattened, aligned, and/or processed to reduce noise, remove artifacts, or remove stray light intensities from the image data.

After the memory copy operation, in block 606, a first kernel (e.g., Kernel 1) in which the current estimate for the high-resolution image (e.g., a portion of the sample spectrum) and the pupil function are combined (e.g., multiplied) in the Fourier domain is executed (for convenience, the combined high-resolution image and pupil function is referred to as an estimated “exit wave” as described in Ou et al.). In block 608, the Fourier-domain estimated exit wave (e.g., combined estimated high-resolution image and pupil function) is converted to the real domain by performing a batched inverse FFT to generate an estimated exit wave(s) at the imaging device (e.g., image capture device 110). For example, processor 116 may initiate the first kernel call (in block 606) to generate the estimated exit wave (e.g., referred to as forward simulation in Fourier domain) and then initiate a batched inverse FFT (block 608) to convert the estimated exit wave into the time (real) domain. During the batched inverse FFT, the GPU 122a (and/or any other GPU employed) may perform an inverse FFT on each ROI (e.g., in a batched manner) of the estimated exit wave in parallel.

In block 610, a second kernel (e.g., Kernel 2) is executed in which an intensity correction is applied to the estimated exit wave. For example, the low-resolution image data retrieved in block 604 may be employed to update the estimated exit wave (e.g., intensity correct the estimated exit wave based on the current low-resolution image data provided to the GPU in block 604). In some embodiments, operations in block 604 may be performed asynchronously (e.g., as long as the required data is present for intensity correction in block 610). Correction of the exit wave is dependent on the FPM reconstruction algorithm employed. For example, in Ou et al., the intensity correction includes replacing the modulus of the estimated (e.g., simulated) exit wave with the square root of the low-resolution image intensity. In some embodiments, intensity correction may include identifying each pixel within each ROI of the estimated exit wave and the current low-resolution image used for intensity correction and performing intensity correction on the estimated exit wave on a pixel-by-pixel basis in parallel on one or more GPUs.

Following intensity correction, in block 612, the intensity-corrected, estimated exit wave is converted to the Fourier domain (e.g., via a batched forward FFT initiated by processor 116 and performed in parallel on each ROI of the intensity-corrected, estimated exit wave, on a pixel-by-pixel basis, using the GPU 122a and/or another GPU) and, in block 614, the sample spectrum and pupil function are updated based on the intensity-corrected, estimated exit wave (e.g., via a third kernel call (Kernel 3) initiated by processor 116 and executed by GPU 122a). For example, the sample spectrum and pupil function may be updated based on a difference between the exit wave before and after intensity correction in block 610 as described in Ou et al. As mentioned, in embodiments in which the pupil function is predetermined, updating the pupil function is optional.

Blocks 604-614 are repeated for each low-resolution image (e.g., each low-resolution image 112a-n). In other words, for each low-resolution image or portion of each low resolution image (e.g., a predetermined number of ROIs based on GPU architecture and GPU memory availability), low-resolution image data may be uploaded to a GPU (e.g., in block 604), an estimated exit wave may be created for the current estimated high-resolution image (e.g., a portion of the sample spectrum) and pupil function (e.g., in block 606), the estimated exit wave may be transformed to the real domain (e.g., in block 608), the estimated exit wave may be intensity corrected with the low-resolution image data uploaded to the GPU (e.g., in block 610), the intensity-corrected, estimated exit wave may be transformed into the Fourier domain (e.g., in block 612), and the estimated high-resolution image and pupil function may be updated based on the intensity-corrected, estimated exit wave (e.g., in block 614).

In block 616, it is determined whether all of the low-resolution images have been employed to update the estimated high-resolution image (and pupil function). If not, blocks 604-614 are repeated for the remaining low-resolution images; otherwise, method 600 proceeds to decision block 618.

In block 618, it is determined whether the estimated high-resolution image has converged to an acceptable level or whether a maximum number of iterations have been performed. For example, simulated low resolution images from the estimated high-resolution image may be compared to one or more of the low-resolution images to confirm that the estimated high-resolution image accurately depicts the details of the low-resolution image(s). In some embodiments, this may include simulating a low-resolution image from the estimated high-resolution image (e.g., intentionally reducing the detail within the high-resolution image to approximate the level of detail within the low-resolution images).

Assuming the estimated high-resolution image has not yet converged relative to the low-resolution images, updating of the estimated high-resolution image and pupil function may be repeated using each low-resolution image (e.g., in blocks 604-614). Repeating the update of the estimated high-resolution image and pupil function may continue until the estimated high-resolution image converges or until a maximum number of iterations has been reached (e.g., a maximum number of times the estimated high-resolution image is updated with the same set of low-resolution images). In some embodiments, the maximum number of iterations may range from 2 to 10 iterations, although other numbers of iterations may be employed. In one or more embodiments, convergence checking may be omitted, and a predetermined number of iterations may be performed based on prior information, for example.

Assuming the estimated high-resolution image has reached sufficient convergence with the low-resolution images, or the maximum number of iterations has been reached (e.g., as determined by processor 116 in block 618), in block 620, the high-resolution reconstructed image is output. For example, each of the ROIs of the estimated high-resolution image (e.g., stored in a linear array in memory 128a of GPU 122a, for example) may be combined and output as the reconstructed high-resolution image. As stated, in some embodiments, the GPU 122a or the processor 116 may cause or facilitate the high-resolution image data to be stored (e.g., in memory 118 and/or 120) and/or output the high-resolution image via user interface 126 of display 124 (FIG. 1A). In some embodiments, reconstructed image data may be transferred to external storage (e.g., local external storage, cloud storage, etc.).

FIG. 7 illustrates another example method 700 of employing a GPU for FPM reconstruction in which a single kernel call is employed in accordance with embodiments provided herein. With reference to FIG. 7, FPM reconstruction may be started in block 701 in which a memory copy is performed to retrieve pre-processed low-resolution image data for all of the low-resolution images for transfer to one or more GPUs and to be used during FPM reconstruction (e.g., all image data for low-resolution images 112a-n). For example, processor 116 may initiate a memory copy operation to transfer low-resolution image data from memory 118 of processor 116 to memory 128a of GPU 122a. Low-resolution image data may contain data of a fraction of the total number of ROIs suitable to GPU memory availability. If the GPU has insufficient memory to store all of the low-resolution image data, subsequent memory copy operations may be performed. In other embodiments, GPU hardware with sufficient compute capability may allow for optimized paging functionality to retrieve data on an as-need basis. As stated, pre-processed image data may include low-resolution image data that is flattened, aligned, and/or processed to reduce noise, remove artifacts, or remove stray light intensities from the image data.

In block 702, an initial guess is made for the sample spectrum and the pupil function. As stated, the initial guess for the sample spectrum is a frequency-domain estimate of the high-resolution image that will be produced by FPM reconstruction using the low-resolution images. Any suitable initial guess may be employed for the sample spectrum (e.g., estimated high-resolution image) and/or the pupil function, and such an initial guess may be dependent upon the particular FPM algorithm(s) and/or pupil function recovery algorithm(s) employed during FPM reconstruction. Example initial guesses for the sample spectrum and pupil function are described above with reference to block 602 of method 600.

In embodiments in which the pupil function of the optical system (e.g., optical system 106) is measured, estimated, or otherwise determined prior to FPM reconstruction, no initial guess for the pupil function is required, and the pupil function may be uploaded for use during FPM reconstruction (e.g., to GPU 122a and/or any other GPU employed).

Following an initial guess for the sample spectrum and/or pupil function, a single kernel 703 (e.g., Giant Kernel) is executed to perform FPM reconstruction based on the initial sample spectrum and pupil function. As described below, the single kernel 703 call may include blocks 704, 706, 710, and 712. In some embodiments, processor 116 (FIG. 1A) may initiate (e.g., via a kernel call) execution of the single kernel 703 by GPU 122a and/or any other GPU employed. As will also be described below, use of a single kernel call that processes all image data for all low-resolution images significantly decreases the time required for high-resolution image reconstruction.

Referring to the single kernel 703, in block 704, the current estimate for the high-resolution image (e.g., a portion of the sample spectrum) and the pupil function are combined (e.g., multiplied) in the Fourier domain to form an estimated exit wave as described above with reference to block 606 of method 600, and the Fourier-domain estimated exit wave (e.g., combined estimated high-resolution image and pupil function) is converted to the real domain by performing a batched inverse FFT (e.g., a custom FFT implementation on a GPU that may be embedded into a single kernel that will allow near pixel-level parallelization) to generate an estimated exit wave(s) at the imaging device (e.g., image capture device 110), as described above with reference to block 608 of method 600. Thus, block 704 performs similar operations to both blocks 606 and 608 of method 600.

In block 706, an intensity correction is applied to the estimated exit wave as described previously with reference to block 610 of method 600. For example, the low-resolution image data from a first of the low-resolution images (e.g., low-resolution image 112a) may be employed to update the estimated exit wave (e.g., intensity correct the estimated exit wave based on low-resolution image data). Thus, block 706 performs a similar operation to block 610 of method 600.

Following intensity correction, in block 708, the intensity-corrected, estimated exit wave is converted to the Fourier domain (e.g., via a batched forward FFT performed in parallel on each ROI of the intensity-corrected, estimated exit wave, on a pixel-by-pixel basis, using the GPU 122a), and the sample spectrum and pupil function are updated based on the intensity-corrected, estimated exit wave. For example, the sample spectrum and pupil function may be updated based on a difference between the exit wave before and after intensity correction in block 706, as described in Ou et al. As mentioned, in embodiments in which the pupil function is predetermined, a pupil function update is optional. Thus, block 708 performs similar operations to both blocks 612 and 614 of method 600.

Blocks 704-708 are repeated for each low-resolution image (e.g., each low-resolution image 112a-n). In other words, for each low-resolution image or portion of each low resolution image (e.g., a predetermined number of ROIs based on GPU architecture and GPU memory availability), an estimated exit wave may be created for the current estimated high-resolution image and pupil function and transformed to the real domain (in block 704), the estimated exit wave may be intensity corrected with the low-resolution image data uploaded to the GPU (in block 706), the intensity-corrected, estimated exit wave may be transformed into the Fourier domain, and the estimated high-resolution image and pupil function may be updated based on the intensity-corrected, estimated exit wave (e.g., in block 708).

In block 710, it is determined whether all of the low-resolution images have been employed to update the estimated high-resolution image (e.g., and pupil function). If not, blocks 704-708 are repeated; otherwise, in block 712, it is determined whether the estimated high-resolution image has converged to an acceptable level or whether a maximum number of iterations have been performed (e.g., as described previously with reference to block 618 of method 600). Assuming simulated low resolution images from the estimated high-resolution image have not yet converged relative to the low-resolution images, updating of the estimated high-resolution image and pupil function may be repeated using each low-resolution image (e.g., in blocks 704-708). Repeating the update of estimated high-resolution image and pupil function may continue until the estimated high-resolution image converges or until a maximum number of iterations has been reached (e.g., a maximum number of times the estimated high-resolution image is updated with the same set of low-resolution images). As stated, in some embodiments, the maximum number of iterations may range from 2 to 10 iterations, although other numbers of iterations may be employed. In one or more embodiments, convergence checking may be omitted, and a predetermined number of iterations may be performed based on prior information, for example.

Assuming the estimated high-resolution image has reached sufficient convergence with the low-resolution images, or the maximum number of iterations has been reached, in block 714, the high-resolution reconstructed image is output. For example, each of the ROIs of the estimated high-resolution image (e.g., stored in a linear array in memory 128a of GPU 122a) may be combined and output as the reconstructed high-resolution image.

Embodiments described herein may employ one or more GPUs to allow pixel-level parallelization during FPM reconstruction. Use of pixel-level parallelization may allow for significant performance improvements. GPU computation may use a single instruction multiple threads (SIMT) execution model with kernels designed to be executed on each recruited thread simultaneously. To further improve performance, embodiments described herein may minimize memory copy operations and kernel calls by designing large kernels that operate on all ROIs of an image in parallel (e.g., using pixel-level parallelization) within a single kernel call (as described in method 600 of FIG. 6). Such an improvement may allow greater than a 500 times improvement in FPM reconstruction time compared to a serial CPU implementation.

As described above, in some embodiments, a full physics model may be employed (e.g., via pupil function recovery) to improve high-resolution image quality. The systems and methods provided herein are portable to different GPU architectures and hardware configurations and may enable high throughput FPM imaging with reduced implementation costs.

To further improve performance, embodiments described herein may reduce memory copy operations and kernel calls by embedding FFT calculations within another kernel and through use of optimized thread synchronization, where an entire FPM reconstruction of all ROIs, or a fraction of ROIs, of all low-resolution images are carried out with a single kernel call (as described in method 700 of FIG. 7). Doing so will also allow efficient utilization of shared memory, texture memory, local registers, and caching, minimizing DRAM access that may have relatively higher latency. This may allow more than a 10,000 times improvement in FPM reconstruction time compared to a serial CPU implementation.

As described above, in some embodiments, a Fourier ptychographic imaging system may include: a plurality of light sources configured to emit light onto a sample location; an optical system configured to image at least a portion of a sample positioned at the sample location; an image capture device configured to capture images of the sample through the optical system under different light conditions provided by the plurality of light sources; a processor; a GPU in communication with the processor; and a memory coupled to the processor.

In one or more embodiments, the memory may include computer executable instructions stored therein that, when executed by the processor, cause the processor to: obtain images of a sample positioned at the sample location; store the images in the memory; upload the images to the GPU; and initiate FPM reconstruction using the GPU to generate a reconstructed image. The FPM reconstruction may include performing portions of the FPM reconstruction in parallel on the GPU to reduce FPM reconstruction time.

In some embodiments, the processor may be configured to control operation of at least one light source of the plurality of light sources and the image capture device. The processor may also be configured to initiate FPM reconstruction by calling a kernel of the GPU. For example, FPM reconstruction may be initiated in the response to a single kernel call or a sequence of kernel calls (e.g., multiple kernel calls) and FFT calls.

In some embodiments, a GPU is configured to generate a reconstructed image from a plurality of images by, for each image: defining a plurality of regions of interest within the image; performing FPM reconstruction on each region of interest independently of other regions of interest within the image; and generating the reconstructed image from the FPM reconstruction of each region of interest within each image. Each region of interest within each image may include a predefined number of pixels within the image. In some embodiments, at least some adjacent regions of interest may share one or more image pixels. Any suitable region of interest size may be employed. Factors that may influence region of interest size may include the optical system used, the computer architecture used, the number of GPU cores available, or the like. As stated, in at least some embodiments, all regions of interest of an image and all pixels of each region of interest, and thus all pixels of the image, may be processed simultaneously during FPM reconstruction using a GPU.

The GPU may be configured to perform FPM reconstruction on each region of interest of each image in parallel, such as by performing pixel-level parallelization. The GPU also may be configured to perform FPM reconstruction of one or more regions of interest by selecting an FPM algorithm and applying the selected FPM algorithm to the one or more regions of interest. In some embodiments, the GPU may be configured to perform FPM reconstruction on one or more low-resolution regions of interest and generate one or more FPM reconstructed regions of interest having a larger number of pixels (e.g., 2 to 4 times more pixels) than the one or more low-resolution regions of interest. Some reconstructed ROIs may have the same number of pixels as the low-resolution ROIs employed to generate the reconstructed ROIS.

In some embodiments, a different pupil function may be used for each ROI of an image, while in other embodiments one or more ROIs of an image may share a pupil function. In yet other embodiments, a common pupil function may be used for all ROIs of an image.

In one or more embodiments, a pupil function may be generated for a first reconstruction iteration and then reused for subsequent reconstruction iterations, while in other embodiments, a pupil function may be generated (e.g., for each ROI or one or more ROIs) during each reconstruction iteration.

The foregoing description discloses only example embodiments of the invention; modifications of the above disclosed apparatus and methods that fall within the scope of the invention will be readily apparent to those of ordinary skill in the art. Accordingly, while the present invention has been disclosed in connection with the example embodiments thereof, it should be understood that other embodiments may fall within the spirit and scope of the invention, as defined by the following claims.

The elements and features recited in the appended claims may be combined in different ways to produce new claims that likewise fall within the scope of the present invention. Thus, whereas the dependent claims appended below depend on only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

What is claimed is:

1. A method of Fourier ptychography microscopy (FPM), the method comprising:
obtaining images of a sample using an FPM system;
storing the images in a memory;
uploading the images to a graphics processing unit (GPU); and
performing FPM reconstruction using the GPU, such that a reconstructed image is generated, wherein the FPM reconstruction includes performing portions of the FPM reconstruction in parallel on the GPU, such that FPM reconstruction time is reduced.

2. The method of claim 1, wherein the storing of the images in the memory comprises storing image data from the images in a memory of a central processing unit (CPU).

3. The method of claim 2, wherein the uploading of the images to the GPU comprises transferring image data from the memory of the CPU to a memory of the GPU.

4. The method of claim 1, wherein the performing of the FPM reconstruction comprises:
performing a single kernel call; or
performing a sequence of kernel calls and fast Fourier transform (FFT) calls.

5. The method of claim 1, wherein the obtaining of the images of the sample comprises:
for each of the images, employing an array of light sources, such that the sample is illuminated using light generated by one or more light sources of the array of light sources.

6. The method of claim 5, wherein, for each of the images, different light sources or different arrangements of light sources are employed to illuminate the sample.

7. The method of claim 1, wherein the storing of the images in the memory comprises flattening and aligning image data in the memory.

8. The method of claim 7, wherein the storing of the images in the memory comprises:
defining a plurality of regions of interest within each of the images; and
flattening and aligning image data region of interest by region of interest in the memory.

9. The method of claim 1, wherein the uploading of the images to the GPU comprises transferring image data to the GPU and preprocessing image data within the GPU.

10. The method of claim 9, wherein the preprocessing of the image data within the GPU comprises reducing noise in the image data, removing artifacts from the image data, removing stray light intensities from the image data, or any combination thereof.

11. The method of claim 1, further comprising:
preprocessing image data stored in the memory, the preprocessing comprising reducing noise in the image data, removing artifacts from the image data, removing stray light intensities from the image data, or any combination thereof.

12. The method of claim 1, wherein the performing of the FPM reconstruction comprises employing at least one pupil function representative of an optical system of the FPM system during the FPM reconstruction of the reconstructed image.

13. The method of claim 12, wherein the employing of the at least one pupil function comprises:
uploading the at least one pupil function to the GPU; and
employing the at least one pupil function during the FPM reconstruction of the reconstructed image.

14. The method of claim 12, wherein the employing of the at least one pupil function comprises:
reconstructing the at least one pupil function; and
employing the at least one pupil function during the FPM reconstruction of the reconstructed image.

15. The method of claim 12, wherein the employing of the at least one pupil function comprises: employing a first pupil function during the FPM reconstruction of a first region of interest of image data; and
employing a second pupil function during the FPM reconstruction of a second region of interest of image data.

16. The method of claim 1, wherein the performing of the FPM reconstruction comprises:
for each of the images:
defining a plurality of regions of interest within the respective image; and
performing FPM reconstruction on each region of interest of the plurality of regions of interest independently of other regions of interest of the plurality of regions of interest within the respective image; and
generating the reconstructed image from the FPM reconstruction of each region of interest within each of the images.

17. The method of claim 16, wherein each region of interest of the plurality of regions of interest within each of the images comprises a predefined number of pixels within the respective image.

18. The method of claim 16, wherein at least some adjacent regions of interest of the plurality of regions of interest share one or more image pixels.

19. The method of claim 16, wherein the performing of the FPM reconstruction of each region of interest of the plurality of regions of interest of each of the images comprises performing FPM reconstruction on each region of interest of the plurality of regions of interest in parallel using the GPU.

20. The method of claim 19, wherein the performing of the FPM reconstruction on each region of interest of the plurality of regions of interest in parallel using the GPU comprises performing pixel-level parallelization.

21. The method of claim 19, wherein the performing of the FPM reconstruction on each region of interest of the plurality of regions of interest in parallel using the GPU comprises performing a single kernel call.

22. The method of claim 16, wherein the performing of the FPM reconstruction of one or more regions of interest of the plurality of regions of interest comprises:
selecting an FPM algorithm; and
applying the selected FPM algorithm to the one or more regions of interest.

23. The method of claim 22, wherein the FPM algorithm comprises a pupil function recovery algorithm.

24. The method of claim 16, wherein the FPM reconstruction performed on one or more low-resolution regions of interest of the plurality of regions of interest generates one or more FPM reconstructed regions of interest having a larger number of pixels than the one or more low-resolution regions of interest.

25. The method of claim 1, wherein the performing of the FPM reconstruction using the GPU, such that the reconstructed image is generated comprises employing a plurality of GPUs to generate the reconstructed image.

26. A Fourier ptychographic imaging system comprising:
a plurality of light sources configured to emit light onto a sample location;
an optical system configured to image at least a portion of a sample positioned at the sample location;
an image capture device configured to capture images of the sample through the optical system under different light conditions provided by the plurality of light sources;
a processor;
a graphics processing unit (GPU) in communication with the processor; and
a memory coupled to the processor, the memory including computer executable instructions stored therein that, when executed by the processor, cause the processor to:
obtain the images of the sample positioned at the sample location;
store the images in the memory;
upload the images to the GPU; and
initiate Fourier ptychography microscopy (FPM) reconstruction using the GPU, such that a reconstructed image is generated,
wherein the FPM reconstruction includes performance of portions of the FPM reconstruction in parallel on the GPU, such that FPM reconstruction time is reduced.

27. The Fourier ptychographic imaging system of claim 26, wherein the processor is configured to control operation of the plurality of light sources, the image capture device, or the plurality of light sources and the image capture device.

28. The Fourier ptychographic imaging system of claim 26, wherein the processor is configured to initiate at least a portion of FPM reconstruction by calling a kernel of the GPU.

29. The Fourier ptychographic imaging system of claim 26, further comprising:
a display configured to output the reconstructed image.

30. The Fourier ptychographic imaging system of claim 26, wherein the memory includes computer executable instructions that, when executed by the processor, further cause the processor to:
perform a single kernel call; or
perform a sequence of kernel calls and fast Fourier transform (FFT) calls.

31. The Fourier ptychographic imaging system of claim 26, wherein the GPU is configured to employ at least one pupil function representative of the optical system of the Fourier ptychographic imaging system during FPM reconstruction of the reconstructed image.

32. The Fourier ptychographic imaging system of claim 26, wherein the GPU is configured to generate the reconstructed image, the GPU being configured to generate the reconstructed image comprising the GPU being configured to:
for each of the images:
define a plurality of regions of interest within the respective image; and
perform FPM reconstruction on each region of interest of the plurality of regions of interest independently of other regions of interest of the plurality of regions of interest within the respective image; and
generate the reconstructed image from the FPM reconstruction of each region of interest of the plurality of regions of interest within each of the images.

33. The Fourier ptychographic imaging system of claim 32, wherein each region of interest of the plurality of regions of interest within each of the images comprises a predefined number of pixels within the respective image.

34. The Fourier ptychographic imaging system of claim 32, wherein at least some adjacent regions of interest of the plurality of regions of interest share one or more image pixels.

35. The Fourier ptychographic imaging system of claim 32, wherein the GPU is configured to perform FPM reconstruction on each region of interest of the plurality of regions of interest in parallel.

36. The Fourier ptychographic imaging system of claim 35, wherein the GPU is configured to perform pixel-level parallelization.

37. The Fourier ptychographic imaging system of claim 32, wherein the GPU is configured to perform FPM reconstruction of one or more regions of interest of the plurality of regions of interest, wherein the GPU is configured to:
select an FPM algorithm; and
apply the selected FPM algorithm to the one or more regions of interest.

38. The Fourier ptychographic imaging system of claim 37, wherein the FPM algorithm comprises a pupil function recovery algorithm.

39. The Fourier ptychographic imaging system of claim 32, wherein the GPU is configured to:
perform FPM reconstruction on one or more low-resolution regions of interest of the plurality of regions of interest; and
generate one or more FPM reconstructed regions of interest having a larger number of pixels than the one or more low-resolution regions of interest.

40. The Fourier ptychographic imaging system of claim 26, further comprising:
a plurality of GPUs, the plurality of GPUs comprising the GPU.
